(19) United States
(12) Patent Application Publication
(10) Pub. No.: US 2015/0000197 A1
(43) Pub. Date: Jan. 1, 2015

(54) Adjustable Transmissive Insulative Array of Vanes, System and Building Structure

(71) Applicant: The University of Bristish Columbia, Vancouver (CA)

(72) Inventor: Lorne A. Whitehead, Vancouver (CA)

(21) Appl. No.: 14/360,604

(22) PCT Filed: Nov. 23, 2012
(86) PCT No.: PCT/CA12/50848

§ 371 Date: May 23, 2014

Related U.S. Application Data
(60) Provisional application No. 61/563,585, filed on Nov. 24, 2011.

(51) Int. Cl. E04D 13/03; E04D 13/035; E06B 7/086; G02B 5/10; E06B 9/264

(52) U.S. Cl. CPC E04D 13/033; G02B 5/10; E06B 9/264; E06B 7/086; E04D 13/035
USPC 49/64; 359/853

(57) ABSTRACT

An adjustable transmissive insulative array of vanes comprising a plurality of parallel longitudinally extending and transversely spaced vanes, each vane rotatable about its longitudinal axis between an insulative state and a transmissive state, each vane comprising an insulative body and a reflective layer on the outer surface of the body, the insulative body of each vane shaped such that in the insulative state the vane is operable to engage with adjacent vanes to form a substantially continuous insulating boundary, the insulative body of each vane further shaped such that in the transmissive state the vane cooperates with an adjacent vane to form an optical concentrator therebetween comprising a portion of the reflective layer of the vane and an portion of the reflective layer of the adjacent vane, each optical concentrator operable to transmit received light through the array of vanes.

### TECHNICAL FIELD

The present disclosure relates to an adjustable transmissive insulative array of vanes, system and building structure using the array of vanes and system.

### BACKGROUND

During sunny weather conditions it is often desirable to maximize the transmission of sunlight into a building to assist with both lighting and heating of the interior of the building. By contrast, during dark, cloudy, or cold weather conditions it is often desirable to maximize the thermal insulation of a building to minimize heat loss from the building. Windows are typically employed in buildings to facilitate the transmission of sunlight into the building while also providing a sealed barrier against the entry of wind, rain, snow and other undesirable elements. While windows typically provide a relatively high degree of optical transmission which may be advantageous for sunny weather conditions, they also typically provide a relatively low degree of thermal insulation which may be undesirable for dark, cloudy, or cold weather conditions.

Attempts have been made to develop solutions that provide both a high degree of optical transmission and a high degree of thermal insulation. However, many of these solutions have failed to provide sufficient sunlight transmission or thermal insulation, require frequent adjustment throughout the day, are costly, or are overly complex.

### SUMMARY

According to one aspect, the disclosure provides an adjustable transmissive insulative array of vanes comprising a plurality of parallel longitudinally extending and transversely spaced vanes, each vane rotatable about its longitudinal axis between a thermally insulative state and an optically transmissive state, each vane comprising a thermally insulative body and an optically reflective layer on the outer surface of the body, the insulative body of each vane shaped such that in the insulative state the vane is operable to engage with adjacent vanes to form a substantially continuous thermally insulating boundary, the insulative body of each vane further shaped such that in the transmissive state the vane cooperates with an adjacent vane to form an optical concentrator therebetween comprising a portion of the reflective layer of the vane and an portion of the reflective layer of the adjacent vane, each optical concentrator operable to transmit received light through the array of vanes.

The optical concentrator may be a compound parabolic concentrator. The insulative body of each vane may be further shaped such that in the insulative state the vane is partially overlapping with adjacent vanes. The array of vanes may be housed within a multi-paned window or skylight structure. The insulative body may comprise an insulating material selected from the group consisting of: foam, polystyrene foam, or a hollow polystyrene body filled with cellulose fiber mat or other low cost insulative material. The reflective layer may be selected from the group consisting of: metallic film, aluminized polyester film, multi-layer film, aluminized Mylar, or mirror film.

According to another aspect, the disclosure provides a system comprising: an array of vanes; and an optical reflective directing element positioned with respect to the array of vanes to direct sunlight received by the optical reflective directing element towards the array.

According to still another aspect, the disclosure provides A building structure comprising: at least one above-described array of vanes or system. In some embodiments, the building structure has a roof and walls. The at least one array of vanes or system can be installed near the roof and/or walls of the building structure from inside or outside. The at least one array of vanes or system can also be installed as part of the roof and/or walls.

### BRIEF DESCRIPTION OF THE DRAWINGS

FIG. 1 is a side elevation cross-sectional view of an array of vanes configured in an insulative state according to an embodiment.

FIG. 2 is a side elevation cross-sectional view of the array of vanes shown in FIG. 1 configured in a transmissive state.

FIG. 3 is a side elevation cross-sectional view of a system having an optical directing element cooperating with an array of vanes according to an embodiment.

FIG. 4 is a side elevation cross-sectional view of a system having an optical directing element cooperating with an array of vanes according to another embodiment.

FIG. 5 is an isolated side elevation cross-sectional view of a pair of adjacent vanes in the array of vanes shown in FIG. 2.

FIGS. 6A, 6B and 6C depict a building structure according to another embodiment, wherein FIG. 6A is a perspective view of the building structure, FIG. 6B is a cross-sectional view of the building structure in the transmissive state and FIG. 6A is a cross-sectional view of the building structure in the insulative state.

### DETAILED DESCRIPTION

The embodiments described in the present disclosure relate to an adjustable transmissive insulative array of vanes. In particular, the embodiments relate to an array of vanes configured to be adjustable between a thermally insulative state and an optically transmissive state.

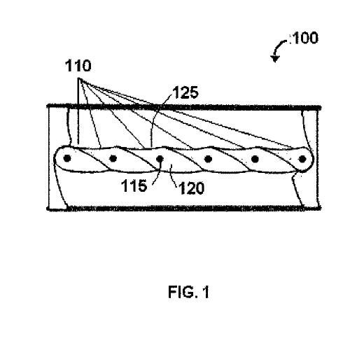

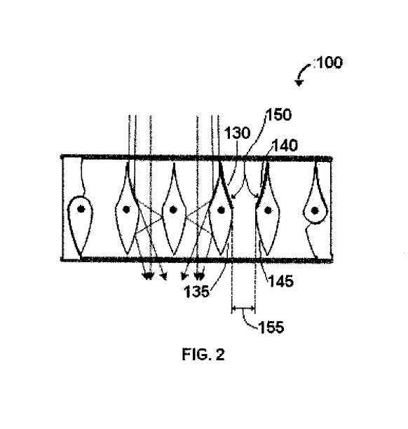

Referring to FIGS. 1 and 2, side elevation cross-sectional views of a first embodiment of an array of vanes 100 are shown in a thermally insulative state and an optically transmissive state. The array 100 generally comprises a plurality of parallel longitudinally extending and transversely spaced vanes 110. Each vane 110 generally comprises a thermally insulative body 120 and an optically reflective layer 125 on the outer surface of the body 120. Each vane 110 is rotatable about its longitudinal axis 115 between a thermally insulative state, as shown in FIG. 1, and an optically transmissive state, as shown in FIG. 2. The body 120 of each vane 110 is generally shaped such that (a) in the insulative state, the vane 110 is operable to engage with adjacent vanes 110 to form a substantially continuous thermally insulative boundary, and (b) in the transmissive state, the vane 110 cooperates with an adjacent vane 110 to form an optical concentrator 150 therebetween that is operable to transmit received light through the array of vanes 100.

The body 120 of each vane 110 may be comprised of any suitable insulative material, such as, for example, foam, a hollow polystyrene body filled with cellulose fibre mat, or any low density, low thermal conductivity, or low cost material. The reflective layer 125 may be comprised of any suitable visible light reflecting material, such as, for example, metallic film, aluminized polyester film, multi-layer film, aluminized Mylar™, mirror film manufactured by 3M™ or any low thermal conductivity, or low cost reflective films. The reflective layer 125 may cover the entire outer surface of the body 120 or only an active portion thereof.

Referring to FIG. 1, the array 100 is shown with the vanes 110 in the insulative state. In this state, the vanes 110 are rotated about their longitudinal axes 115 such that they engage with adjacent vanes 110 to form a substantially continuous thermally insulative boundary that acts as a thermal barrier to restrict heat transfer through the array 100. The insulative state may be suitably employed during dark or cloudy weather conditions, or cold outdoor temperatures in order to retain heat within a structure. This may advantageously reduce the capital and/or operating costs associated with any indoor heating system(s) where the array 100 is employed. In addition, the insulative state may also be suitably employed during sunny or hot outdoor temperatures in order to allow a controlled amount of sunlight and heat into the structure. For example, the vanes 110 may be set at an intermediate position between the insulative and transmissive states to regulate the amount of sunlight and heat allowed into the structure. This may advantageously reduce the capital and/or operating costs associated with any indoor cooling system(s) where the array 100 is employed.

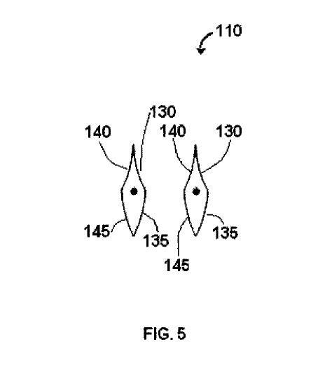

In the present embodiment, each vane 110 generally comprises four longitudinally extending active surfaces 130, 135, 140, and 145, as shown in FIGS. 1, 2, and 5. Referring to FIG. 5, an isolated side elevation cross-sectional view of a pair of adjacent vanes 110 in the array is shown to better illustrate the different active surfaces 130, 135, 140, and 145. Surfaces 130 and 140 comprise generally concave cross-sections that are symmetrical with one another about a plane that is collinear with the longitudinal axis of the vane 110. Surfaces 135 and 145 comprise generally convex cross-sections that are also symmetrical with one another about the same plane that symmetrically divides surfaces 130 and 140. In the insulative state, the surface 140 of each vane 110 is configured to matingly engage with the surface 135 of an adjacent vane 110, and the surface 130 of each vane 110 is configured to matingly engage with the surface 145 of another adjacent vane 110. In this manner, the array 100 provides a substantially continuous insulating boundary formed by surfaces 130 of adjacent vanes 110, and surfaces 145 of adjacent vanes 110, that restricts the transfer of light, heat and air through the array 100 and between adjacent vanes 110. In alternative embodiments, the insulative body 120 of each vane 110 may be comprised of a malleable or compressible material to improve the mating engagement between adjacent vanes 110 and restrict air transfer through the array 100 while in the insulative state. In the present embodiment, the reflective layer 125 covers surfaces 130, 135, 140 and 145. In alternative embodiments, the reflective surface may only cover surfaces 130 and 140. In further alternative embodiments, the reflective layer may only cover an active portion thereof.

Referring to FIG. 2, the array 100 is shown with the vanes 110 in the transmissive state. In this position, the vanes 110 are rotated about their longitudinal axes 115 such that they cooperate with adjacent vanes 110 to form an optical concentrator 150 therebetween that is operable to transmit sunlight through the array 100. Each optical concentrator 150 is comprised of the surface 130 of a first vane 110 and the opposing surface 140 of an adjacent second vane 110. These surfaces 130, 140 cooperate with each other to concentrate sunlight received by the optical concentrator 150 within its angle of acceptance through a gap 155 between the first and second vanes 110. Sunlight that has been transmitted through the gap 155 by the optical concentrator 150 may then continue directly out of the gap 155 and the array 100 without further interaction with the array 100, or it may be reflected by the surface 135 of the first vane 110 and/or the surface 145 of the second vane 110 prior to continuing out of the array 100. Optical principles provide that the angle of acceptance should ideally be no greater than arcsin(1/R), where R is the concentration ratio. Typically the acceptance angle will be less than arcsin(1/R) depending on the shape of the surfaces and other factors. In alternative embodiments, larger acceptance angles may be employed, typically resulting in reduced optical transmission efficiency of the optical concentrator 150.

In the present embodiment, each optical concentrator 150 is configured to generally resemble a compound parabolic concentrator. The compound parabolic concentrator can be advantageously configured to maximize the acceptance angle of the optical concentrator 150 in accordance with the optical principles described above. As applied to the array of vanes 100, the compound parabolic concentrator configuration provides a relatively high degree of optical transmission between adjacent vanes 110 in the array 100. In addition, the compound parabolic concentrator configuration allows the array 100 to provide a relatively high degree of optical transmission over a broad angle of acceptance, thereby reducing or eliminating the need to adjust the array 100 to track the path of the sun throughout the day. The specific shape of each optical concentrator 150 may be influenced by the desired concentration ratio. For example, a higher concentration ratio may permit each of the vanes 100 to have a larger cross-sectional area, which would result in a thicker insulative barrier during the insulative state. Additionally, a typical concentration ratio of about 2 will yield an acceptance angle of about +/−30 degrees. One exemplary shape of an ideal optical concentrator capable of achieving this concentration ratio is described by Winston et. al., Nonimaging Optics, Academic Press, 2004 [ISBN 978-0-12-759751-5]. However, this ideal shape need not be perfectly reproduced to substantially achieve the benefits of the compound parabolic concentrator design. For example, the ideal shape may be approximated by a plurality of linear or planar segments, and the length may be slightly truncated to reduce the size of the array 100 and/or minimize material costs. However, deviation from the ideal shape may result in a reduced optical transmission efficiency of the optical concentrator 150.

As shown in FIGS. 1 and 2, the angular separation of the array of vanes 100 between the insulative state and the transmissive state is approximately 90 degrees. In alternative embodiments however, angular separation between the insulative state and the transmissive state may be more or less than 90 degrees. For example, it may be desirable to adjust the angular separation between the insulative state and the transmissive state in order to optimize the amount of sunlight received by each optical concentrator 150 over the course of the day in accordance with the position of the sun with respect to the array 100. Additionally, when in a transmissive state, the vanes 110 may be set at a position less than 90 degrees from the insulative state. This may assist in controlling the temperature and air flow into a structure in which the array 100 is employed. When applied during warm outdoor temperatures, this may advantageously help to reduce the capital and/or operating costs associated with any indoor cooling system(s) of the structure.

According to another embodiment, at least some of the vanes 110 of the array of vanes 100 are provided with compressible gaskets. The gaskets are intended to improve sealing between adjacent vanes 110 and between the ends of the array 100 and adjacent structure when the array 100 is in its insulative state, thereby reducing heat transfer through the array 110 by reducing air flow past the vanes 110. In particular, the gaskets are intended to reduce the transfer of heat through the vane array when in the insulative state. For example, the gaskets can reduce the loss of heat caused by the tendency of warm air on the inside of a thermal barrier to leak to the outside, and by cooler outside air that leaks in. In one embodiment, the gasket comprises a fibrous non-woven mat that underlies the reflective layer 125, such as fiberglass insulation material. Even though the reflective layer is not necessarily elastomeric, it is expected that a relatively effective air seal can be established by virtue of the reflective layer's flexibility in combination with the compressibility of the underlying non-woven mat. The non-woven mat can be located under the entire reflective layer 125, or only under selected portions of the reflective layer 125, and in particular, those portions which contact each other or the adjacent structure when the array 100 is in the insulative state. The gaskets can also be formed at the ends of the array 100 and/or on the adjacent structure so that, when in the insulative state, a seal can be formed between the array 100 and the adjacent structure. In the embodiment, the adjacent structure is substantially a rectangular frame, in which the vanes 110 are rotatably installed. The frame comprises four sections. A pair of first parallel sections are substantially parallel to the vanes 110 longitudinally on the outer sides of the vane array 100, while a pair of second parallel sections are substantially perpendicular to the longitudinal axes 115 of the vanes 110. Each of the vanes 110 is rotatably connected to the second parallel sections with its two longitudinal ends respectively. The adjacent structure can also comprise a position adjusting mechanism suitable to adjust the vanes 110 between the open/close positions along their longitudinal axes (not shown in the figures). For example, the mechanism can comprise a control rod connected to the vanes 110 and mechanical means connected to the control rod, in a manner similar to the open/close position adjusting mechanism of a conventional window blind. Other types of mechanisms can also be used in the embodiment, as long as they can adjust the vanes 110 between the open/close positions. The gaskets can be formed at the longitudinal ends of each vane 110, extending longitudinally, passing the ends of the vane 110 and covering at least part of the second parallel members. Alternatively, the gaskets can be formed on the second parallel members, covering the longitudinal ends of the vanes 110.

The presence of the gaskets can improve the insulation property of the vane array compared with the situation where the gaskets are not used. In different embodiments, the gaskets may be located in one of, or in various combinations of, the following locations: (1) between adjacent vanes, (2) between the outer vanes and the first parallel sections of the adjacent structure, and (3) between the longitudinal ends of the vanes and the second parallel sections of the adjacent structure. According to some embodiments, the gaskets would provide a sufficient seal such that the reduction in R value caused by air infiltration or exfiltration through gaps between the vanes or between the vanes and adjacent structure is no more than a factor of two compared to a perfect seal between the corresponding surfaces, as might be achieved by gluing or otherwise adhering the surfaces to eliminate the air gaps.

Instead of a fibrous non-woven mat, other compressible materials can be used, such as a compressible elastomeric material like foam rubber or flexible polyurethane foam. By locating the compressible material under the reflective layer 125, it is expected that the gasket will not interfere or minimally interfere with light transmission by the active surfaces 130, 135, 140, 145. However, in some embodiments, the compressible gaskets may be positioned on top of a portion of the reflective layer 125, or in regions of the body 120 of some vanes where such region does not possess reflective layer 125. In embodiments where the compressible gaskets are positioned on top of a portion of the reflective layer, the gasket material may be selected to be optically transparent to maintain high light transmission efficiency.

Further, the compressible gaskets can be combined with an insulative body 120 of each vane 110 comprised of a malleable or compressible material to further improve the mating engagement between adjacent vanes 110 thereby forming a better air seal in the insulative state, or at least reduce the leakage of air through the array 100.

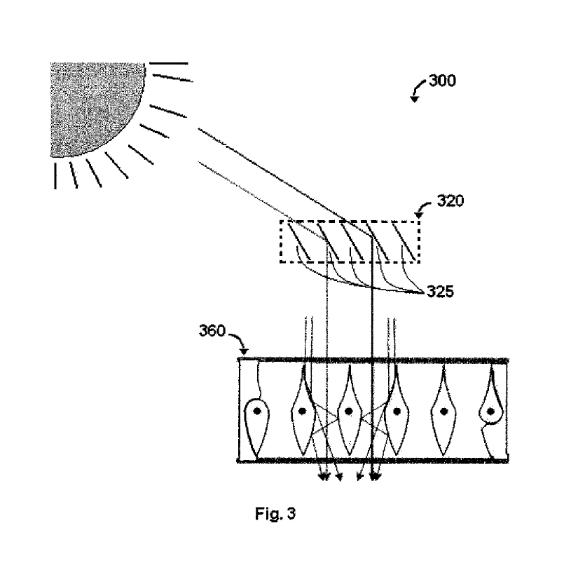

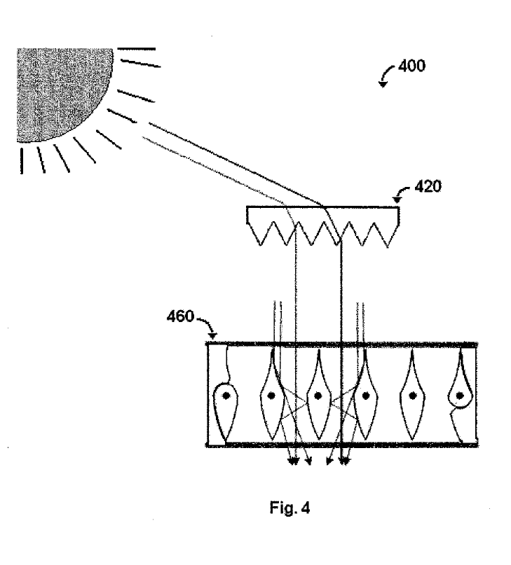

Referring to FIGS. 3 and 4, embodiments of systems 300, 400 comprising an array of vanes 360, 460 and an optical directing element 320, 420 are shown. The array of vanes 360, 460 may comprise the array of vanes 100 described above, or any suitable array of vanes. The optical directing elements 320, 420 function to direct sunlight received by the optical element 320, 420 towards the array 360, 460 within the acceptance angle of the array 360, 460. Accordingly, the optical directing element 320, 420 can be suitably employed to direct sunlight to the array 360, 460 that would otherwise normally be outside the acceptance angle of the array 360, 460.

As shown in FIG. 3, the optical directing element 320 may comprise a series of reflective slats 325. The reflective slats 325 of the optical directing element 320 can be configured to reflect light received by the optical directing element 320 such that the reflected light strikes array 360 at an angle perpendicular to the array 360. In alternative embodiments, the optical directing element 320 may direct the light it receives at a non-perpendicular angle to the array 360, including embodiments where the array 360 has been designed to optimally accept light at a non-perpendicular angle.

FIG. 4 illustrates another embodiment of the system 400 where the optical directing element 420 comprises a prismatic sheet. The prismatic sheet can be configured to refract light received by the optical directing element 420 such that the reflected light strikes array 360 at an angle perpendicular to the array 460. In alternative embodiments the optical directing element 420 may direct the light it receives at a non-perpendicular angle to the array 460, including embodiments where array 360 has been designed to optimally accept light at a non-perpendicular angle.

While the embodiments described above with reference to FIGS. 1 to 5 above illustrate the vanes having particular shapes, it is to be understood that the vanes may have any number of suitable shapes sufficient to perform the operations described above. For example, the length of the vanes in their longitudinal direction can be selected to correspond to a desired opening or fitment for a certain application. The transverse or cross-sectional shape of the vanes can also be varied while achieving the same functionality described above. For example, the body of each vane may have a portion shaped as, but are not limited to, a teardrop, concave, bi-concave, semi-circular, and semi-elliptical shape. Also, the transverse or cross-sectional shape of the vanes need not be symmetrical about a plane. Alternatively, the vanes may comprise a composite or combination of conjugate curved or planar segments. Additionally, while FIGS. 3 and 4 illustrate certain embodiments of the optical directing element 320, 420, in other embodiments the optical directing element 320, 420 may comprise any suitable device of any suitable shape and size that is operable to direct sunlight to the array 360.

In alternative embodiments, the arrays of vanes described above with reference to FIGS. 1 to 5 may be used alongside or in combination with pre-existing window or skylight structures. In further alternative embodiments, the foregoing arrays of vanes may be housed, and optionally sealed, within a multi-paned window or skylight structures such that the arrays are protected from exposure of dirt or other contaminants which could adversely affect their operation. In some embodiments, there are two covers on two sides of the vane array: the side receiving sunlight and the side opposite. The covers, together with the adjacent structure, form a housing that encloses the vane array. The covers can be made of material having high transparency, such as glass, plastic. In some other embodiments, the array of vanes can be used in an “open” structure without being enclosed between two covers or within a housing or sealing. In these embodiments, air can transfer through the array of vans when the array is in the transmissive state or the angular separation.

It is noted that the insulative state herein refers to the fully closed position of the vane array 100, as shown in FIG. 1, which yields a highly thermally insulative characteristic. It is known that energy exchange can occur through radiation, convection and heat conduction. In the fully closed position, the vanes 110 are engaged with each other such that air transfer through the array 100 is significantly restricted. Heat conduction and radiation are also impeded by the engaged vane bodies 110 and the reflective layer 125. On the contrary, the transmissive state refers to the fully open position of the vane array, as shown in FIG. 2, which yields a light-transmissive characteristic. Furthermore, in the open-structure embodiments that the vane array is not enclosed within a housing or sealing, the transmissive state can also allow convection between the two sides of the vane array. According to some embodiments, the transmissive state may yield at least 70% light transmission, namely, 70% or more of the incident sunlight is transmitted through the vane array or system, and the insulative state may yield good thermal insulation.

In addition, while not shown in the figures, it is to be understood that the transition of the foregoing arrays of vanes between insulative and transmissive states can be achieved by any suitable mechanical, electro-mechanical or other transitioning device. For example, the vanes of the array may be coupled to each other and actuated by a control rod to transition the vanes between insulative and transmissive states. In another example, an electro-mechanical actuator could be employed to automate the transitioning of the vanes in an array between insulative and transmissive states. In the alternative, the vanes of the foregoing array of vanes may be rotated by a suitable transitioning device in order to track the position of the sun and optimize the amount of sunlight receivable within the angle of acceptance of the optical concentrators of each array in the transmissive state.

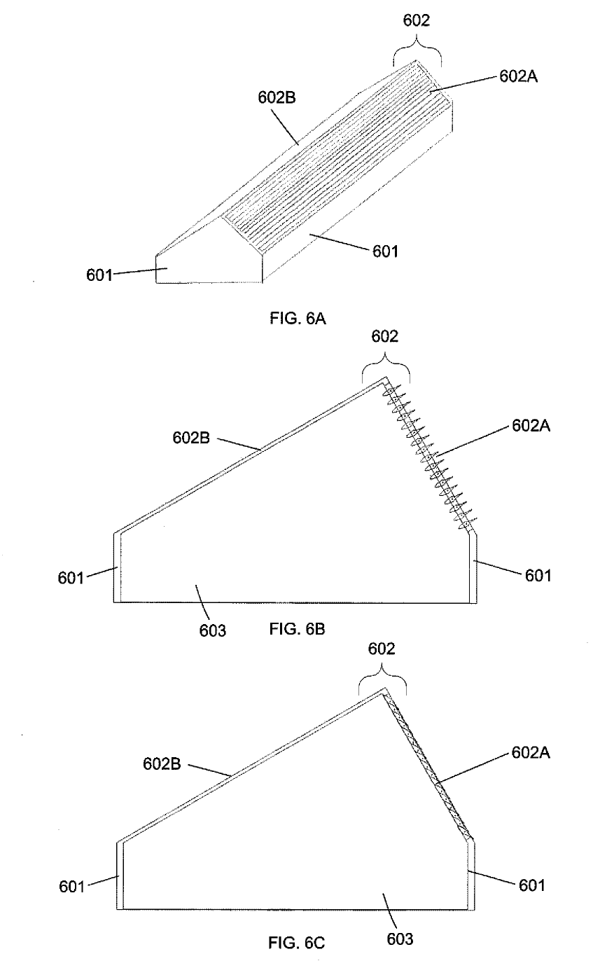

The vane arrays and systems described above can be used in a greenhouse, glasshouse or other building structure, to maximize the thermal insulation to minimize heat loss from the building. FIGS. 6A, 6B and 6C illustrate a building structure, greenhouse 600, according to an embodiment. As shown in the figures, the greenhouse 600 is a structural building having upstanding walls 601 and a roof 602, which enclose an inside greenhouse space 603 therein. The walls 601 may be transparent or opaque, and a door can be provided on one of the walls 601 for access to the inside space (not shown in the figures). The roof 602 and walls 601 can be made of different types of materials, such as glass or plastic, including but not limited to polyethylene film, multiwall sheets of polycarbonate material, or PMMA acrylic glass. The roof 602 and walls 601 can be self-supported or installed onto a supportive frame. The greenhouse 600 heats up because incoming visible solar radiation (for which the glass or plastic is transparent) from the sun is absorbed by plants, soil, and other things inside the building. Air warmed by the heat from hot interior surfaces is retained in the building by the roof and walls. In this embodiment, the roof 602 comprises two sections 602A and 602B which form a “A” shape in cross-section as shown in FIG. 6B. The section 602A of the roof 602 comprises a vane array. Specifically, the size and dimensions of the above-described vane array are tailored to fit into the building structure, such that the vane array forms and functions as section 602A of the roof 602.

While in this embodiment, only section 602A of the roof 602 is integrated with the vane array, one or more vane arrays/systems can be formed as the entire roof 602. Further, one or more vane arrays/systems may also be formed as part of the walls 601.

According to some other embodiments, one or more above-described vane arrays/systems can be positioned below a transparent roof structure or adjacent one or more transparent walls, such that the vane arrays/systems can be opened to allow the transmission of sunlight into the structure and closed to prevent the transmission of sunlight into the structure and also to increase the thermal insulation property of the roof or walls. The vane arrays can be attached to the support structure of the greenhouse, glasshouse or other building structure. For example, when positioned below the roof, the vane array/system can be suspended horizontally near the roof. However, it is noted that the orientation of the vane array/system can be adjusted depending on various factors, such as the structure and layout of the building, maximum receipt of sunshine. Alternatively, the vane arrays/systems can also be positioned near the roof and/or walls from outside of the building.

It is noted that the various embodiment of the vane array and system, as described above, and their combinations, can be used in a greenhouse, glasshouse or other building structure, for example, the vane arrays with or without housing, with or without gaskets, the systems with prismatic sheet or reflective slats. Further, the vane array may also be opened and closed either by manual operation or by automatic control in response to the output of a sensor detecting a selected parameter, such as a sunlight or temperature measurement sensor.

While particular embodiments have been described in the foregoing, it is to be understood that other embodiments are possible and are intended to be included herein. It will be clear to any person skilled in the art that modifications of and adjustments to the foregoing embodiments, not shown, are possible. Further, it is to be understood that the foregoing embodiments and may be applied in a variety of applications, such as, for example, greenhouses, solar heat capture structures, commercial or residential skylights and windows, or for other suitable structures and applications.

1. An adjustable transmissive and insulative array of vanes comprising a plurality of parallel longitudinally extending and transversely spaced vanes, each vane rotatable about its longitudinal axis between a thermally insulative state and an optically transmissive state, each vane comprising a thermally insulative body and an optically reflective layer on the outer surface of the body, the insulative body of each vane shaped such that in the insulative state the vane is operable to engage with adjacent vanes to form a substantially continuous thermally insulating boundary, the insulative body of each vane further shaped such that in the transmissive state the vane cooperates with an adjacent vane to form an optical concentrator therebetween comprising a portion of the reflective layer of the vane and an portion of the reflective layer of the adjacent vane, each optical concentrator operable to transmit received light through the array of vanes.

2. The array of vanes as claimed in claim 1, wherein the optical concentrator is a compound parabolic concentrator.

3. The array of vanes as claimed in claim 1, wherein the insulative body of each vane is further shaped such that in the insulative state the vane is partially overlapping with adjacent vanes.

4. The array of vanes as claimed in claim 1, wherein each of the vanes comprises at least one concave surface extending longitudinally along the vane; and wherein the optical concentrator is formed by the concave surfaces of adjacent vanes.

5. The array of vanes as claimed in claim 4, wherein each of the vanes further comprises at least one convex surface extending longitudinally along the vane; and wherein the convex surface of the vane is engaged with the concave surface of an adjacent vane in the insulative state.

6. The array of vanes as claimed in claim 1, wherein each of the vanes further comprises a compressible gasket extending longitudinally along the vane on at least one surface that is to be engaged with an adjacent vane in the insulative state.

7. The array of vanes as claimed in claim 6, wherein the compressible gasket comprises a compressible layer between the insulative body and the reflective layer, and the reflective layer is flexible and non-elastomeric.

8. The array of vanes as claimed in claim 7, wherein the compressible layer is composed of a fibrous non-woven mat.

9. The array of vanes as claimed in claim 5, wherein each of the vanes comprises two concave surfaces and two convex surfaces that are symmetrical with one another about a plane, which is collinear with the longitudinal axis of the vane.

10. The array of vanes as claimed in claim 1, wherein the insulative body of each vane comprises a compressible material.

11. The array of vanes as claimed in claim 1, wherein the optical concentrator has a concentration ratio of 2 or more.

12. The array of vanes as claimed in claim 1, wherein the optical concentrator has an acceptance angle of at least +/−30°.

13. The array of vanes as claimed in claim 1, wherein each of the vanes have a cross section with shape selected from the group consisting of: a teardrop, concave, bi-concave, semi-circular and semi-elliptical.

14. The array of vanes as claimed in claim 1, wherein the array of vanes is housed within a multi-paned window or skylight structure.

15. The array of vanes as claimed in claim 1, wherein the insulative body comprises an insulating material selected from the group consisting of: foam, polystyrene foam, or a hollow polystyrene body filled with cellulose fibre mat.

16. The array of vanes as claimed in claim 1, wherein the reflective layer is selected from the group consisting of: metallic film, aluminized polyester film, multi-layer film, aluminized Mylar, or mirror film.

17. A system comprising:
the array of vanes as claimed in claim 1; and
an optical directing element positioned with respect to the array of vanes to direct sunlight received by the optical directing element towards the array of vanes within an acceptance angle of the array of vanes.

18. The system as claimed in claim 17, wherein the optical directing element comprises a series of reflective slats or a prismatic sheet.

19. A building structure comprising:
at least one array of vanes as claimed in claim 1.

20. A building structure comprising:
at least one system as claimed in claim 17.
